(19) United States
(12) Patent Application Publication
(10) Pub. No.: US 2024/0244302 A1
(43) Pub. Date: Jul. 18, 2024

(54) SYSTEMS AND METHODS FOR EMBEDDING EXTRACTABLE METADATA ELEMENTS WITHIN A CHANNEL-AGNOSTIC LAYER OF AUDIO-VISUAL CONTENT

(71) Applicant: BANK OF AMERICA CORPORATION, Charlotte, NC (US)

(72) Inventors: Joseph Benjamin Castinado, North Glenn, CO (US); Naoll Addisu Merdassa, Chakopee, MN (US); Brandon Ingram, Charlotte, NC (US); Oscar Guzman, Dallas, TX (US); Kevin Graham Robberts, Charlotte, NC (US); Hope Barus, Fort Mill, SC (US)

(73) Assignee: BANK OF AMERICA CORPORATION, Charlotte, NC (US)

(21) Appl. No.: 18/097,984

(22) Filed: Jan. 17, 2023

(51) Int. Cl. H04N 21/84; H04N 21/431; H04N 21/8547

(52) U.S. Cl. CPC H04N 21/84; H04N 21/4316; H04N 21/8547

(57) ABSTRACT

Embodiments of the present invention provide a system for embedding extractable metadata elements within a channel-agnostic layer of audio-visual content. The system is configured for receiving a content file, determining products displayed in the content file, and delivering resource metadata related to the products displayed in the content file in an interactive and secure manner. The invention may further include various ways in which to automatically display resource metadata in an intuitive manner in conjunction with streaming the content file to a user device via one or more platforms or channels.

### BACKGROUND

Conventional audio and visual content systems do not possess the capability to intuitively embed product data such that a user can easily locate and research items they may be interested in. As such, a need exists for improved audio and visual systems that allow users to easily locate products of interest and potentially conduct a resource action in response to the data presented.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for embedding extractable metadata elements within a channel-agnostic layer of audio-visual content. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention includes the steps of receiving, from a user device, a content file, wherein the content file comprises at least one visual frame; receiving product data for the received content, wherein the product data comprises product identifiers for one or more products displayed within the received content file and one or more timestamps corresponding to when the one or more products are displayed; determining resource data for the one or more products; generating a metadata file containing instructions to automatically trigger the display of the product identifiers and resource data for the one or more products.

In some embodiments, the computer executable instructions cause the computer processor to perform the steps of receiving a request from the user device for displaying the content; and in response to the request, causing the content file and the metadata file to be displayed on the user device.

In some embodiments, causing the content file and metadata file to be displayed on the user device further comprises streaming the content file and metadata file to the user device.

In some embodiments, the metadata is displayed on the user device according to one or more specific timestamps of the one or more products.

In some embodiments, causing the content file and metadata file to be displayed on the user device further comprises displaying a clickable graphical icon overlay over the content file at a specific timestamp range.

In some embodiments, the resource data for the one or more products further comprises product description data, product resource data, and merchant data for the one or more products.

In some embodiments, the resource data further comprises a product price displayed on the user device in a currency according to the geolocation of the user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1a provides a block diagram illustrating a system environment for embedding extractable metadata elements within a channel-agnostic layer of audio-visual content, in accordance with an embodiment of the invention;

FIG. 1b illustrates an exemplary machine learning (ML) subsystem architecture 1000, in accordance with an embodiment of the invention;

FIG. 2 provides a block diagram illustrating the entity system 200 of FIG. 1a, in accordance with an embodiment of the invention;

FIG. 3 provides a block diagram illustrating a resource information determination system 300 of FIG. 1a, in accordance with an embodiment of the invention;

FIG. 4 provides a block diagram illustrating the computing device system 400 of FIG. 1a, in accordance with an embodiment of the invention; and

FIG. 5 provides a process flow for embedding extractable metadata elements within a channel-agnostic layer of audio-visual content, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be a financial institution which may include herein may include any financial institutions such as commercial banks, thrifts, federal and state savings banks, savings and loan associations, credit unions, investment companies, insurance companies and the like. In some embodiments, the entity may be a financial institution that maintains, manages, or provides services to third party entities that sell products, goods, services, or the like to users (e.g., merchants), where the users may or may not be customers of the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to customer or a potential customer of the entity. In some embodiments, the user may not be a customer of the entity. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Typically, audio visual content provided by audio visual content providers (e.g., streaming platforms) may contain various resources (e.g., products, goods, services, or the like). Currently no system exists that can determine resources depicted in audio visual content, provide additional information associated with the resources, and allow users to seamlessly acquire the resources. The system of the present invention solves these problems as explained in detail below.

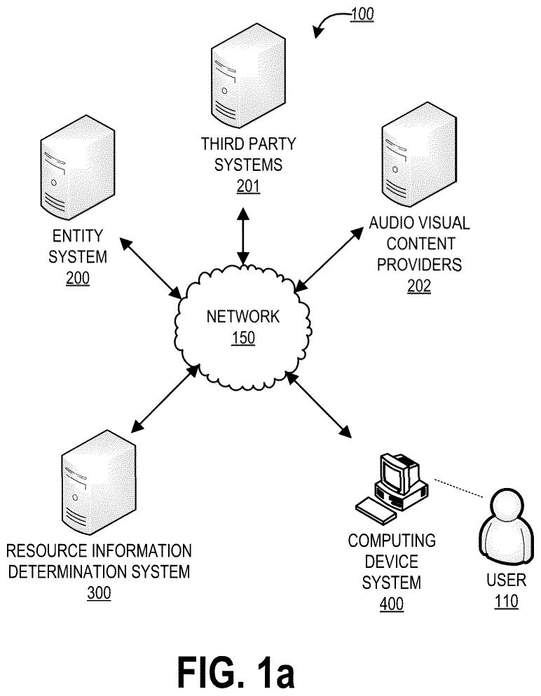

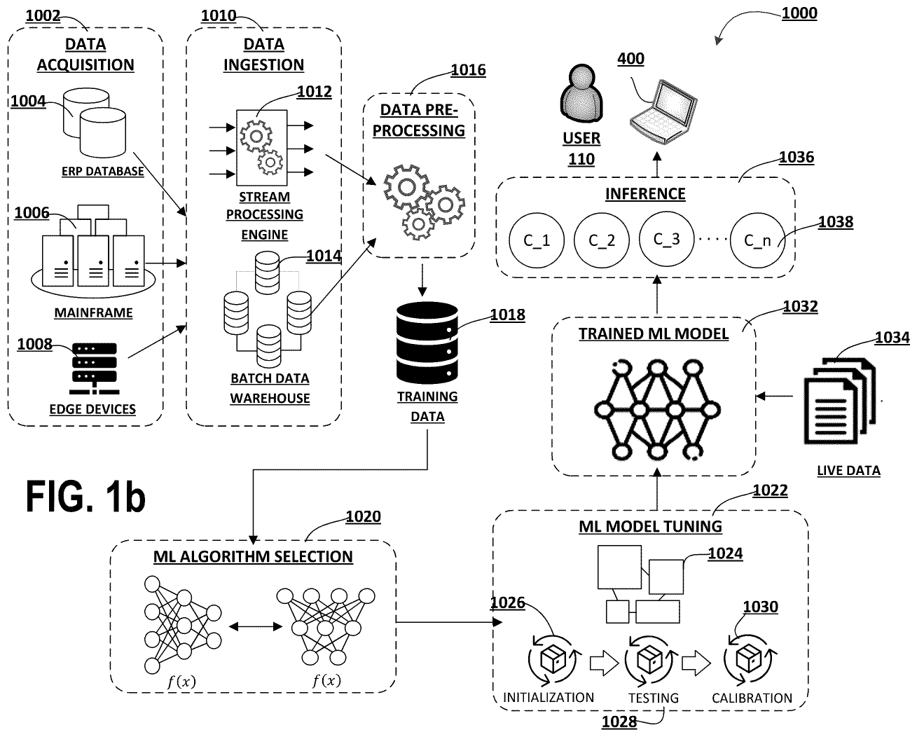

FIG. 1a provides a block diagram illustrating a system environment 100 for embedding extractable metadata elements within a channel-agnostic layer of audio-visual content, in accordance with an embodiment of the invention. As illustrated in FIG. 1a, the environment 100 includes a resource information determination system 300, an entity system 200, one or more third party systems 201, audio visual content providers 202, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may not be customers of the entity. In some embodiments, the one or more users 110 may be potential customers of the entity. In some embodiments, the one or more users 110 may be customers of the third party entity. The one or more third party systems 201 may be associated with third party entities (e.g., merchants) that provide resources to users 110. The audio visual content providers 202 may be any providers that provide audio visual content to users. In some embodiments, the audio visual content providers 202 may be audio visual content providing platform, where audio visual content providing platform may be a web based application, mobile application, a streaming service platform, or the like.

The entity system(s) 200 may be any system owned or otherwise controlled by an entity to support or perform one or more process steps described herein. In some embodiments, the entity is a financial institution. In some embodiments, the entity may be a non-financial institution.

The resource information determination system 300 is a system of the present invention for performing one or more process steps described herein. In some embodiments, the resource information determination system 300 may be an independent system. In some embodiments, the resource information determination system 300 may be a part of the entity system 200.

The resource information determination system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the resource information determination system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the resource information determination system 300, and/or entity system 200 across the network 150.

FIG. 1b illustrates an exemplary machine learning (ML) subsystem architecture 1000, in accordance with an embodiment of the invention. The machine learning subsystem 1000 may include a data acquisition engine 1002, data ingestion engine 1010, data pre-processing engine 1016, ML model tuning engine 1022, and inference engine 1036. It is understood that the machine learning (ML) subsystem architecture 1000 may be a sub-system of resource information determination system 300, in accordance with various embodiments of the invention.

The data acquisition engine 1002 may identify various internal and/or external data sources to generate, test, and/or integrate new features for training the machine learning model 1024. These internal and/or external data sources 1004, 1006, and 1008 may be initial locations where the data originates or where physical information is first digitized. The data acquisition engine 1002 may identify the location of the data and describe connection characteristics for access and retrieval of data. In some embodiments, data is transported from each data source 1004, 1006, or 1008 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 1004, 1006, and 1008 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 1002 from these data sources 1004, 1006, and 1008 may then be transported to the data ingestion engine 1010 for further processing.

Depending on the nature of the data imported from the data acquisition engine 1002, the data ingestion engine 1010 may move the data to a destination for storage or further analysis. Typically, the data imported from the data acquisition engine 1002 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 1002, the data may be ingested in real-time, using the stream processing engine 1012, in batches using the batch data warehouse 1014, or a combination of both. The stream processing engine 1012 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 1014 collects and transfers data in batches according to scheduled intervals, trigger events, or any other logical ordering.

In machine learning, the quality of data and the useful information that can be derived therefrom directly affects the ability of the machine learning model 1024 to learn. The data pre-processing engine 1016 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 1016 may implement feature extraction and/or selection techniques to generate training data 1018. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 1018 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 1022 may be used to train a machine learning model 1024 using the training data 1018 to make predictions or decisions without explicitly being programmed to do so. The machine learning model 1024 represents what was learned by the selected machine learning algorithm 1020 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 1022 may repeatedly execute cycles of experimentation 1026, testing 1028, and tuning 1030 to optimize the performance of the machine learning algorithm 1020 and refine the results in preparation for deployment of those results for consumption or decision making. To this end, the ML model tuning engine 1022 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 1018. A fully trained machine learning model 1032 is one whose hyperparameters are tuned and model accuracy maximized.

The trained machine learning model 1032, similar to any other software application output, can be persisted to storage, file, memory, or application, or looped back into the processing component to be reprocessed. More often, the trained machine learning model 1032 is deployed into an existing production environment to make practical business decisions based on live data 1034. To this end, the machine learning subsystem 1000 uses the inference engine 1036 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 1038) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 1038) live data 1034 based on how similar they are to one another to solve exploratory challenges where little is known about the data, provide a description or label (e.g., C_1, C_2 . . . C_n 1038) to live data 1034, such as in classification, and/or the like. These categorized outputs, groups (clusters), or labels are then presented to the user input system 130. In still other cases, machine learning models that perform regression techniques may use live data 1034 to predict or forecast continuous outcomes.

It will be understood that the embodiment of the machine learning subsystem 1000 illustrated in FIG. 1b is exemplary and that other embodiments may vary. As another example, in some embodiments, the machine learning subsystem 1000 may include more, fewer, or different components.

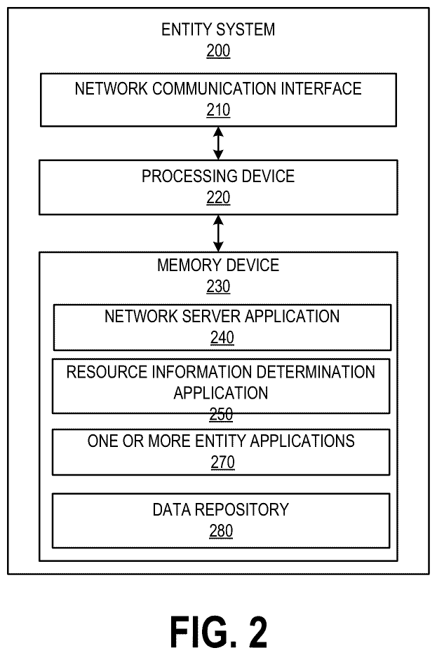

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a resource information determination application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the resource information determination application 250, the one or more entity application 270 to perform certain logic, data-extraction, and data-storing functions of the entity system 200 described herein, as well as communication functions of the entity system 200.

The network server application 240, the resource information determination application 250, and the one or more entity applications 270 are configured to store data in the data repository 280 or to use the data stored in the data repository 280 when communicating through the network communication interface 210 with the resource information determination system 300, and/or the computing device system 400 to perform one or more process steps described herein. In some embodiments, the entity system 200 may receive instructions from the resource information determination system 300 via the resource information determination application 250 to perform certain operations. The resource information determination application 250 may be provided by the resource information determination system 300. The one or more entity applications 270 may be any of the applications used, created, modified, facilitated, and/or managed by the entity system 200.

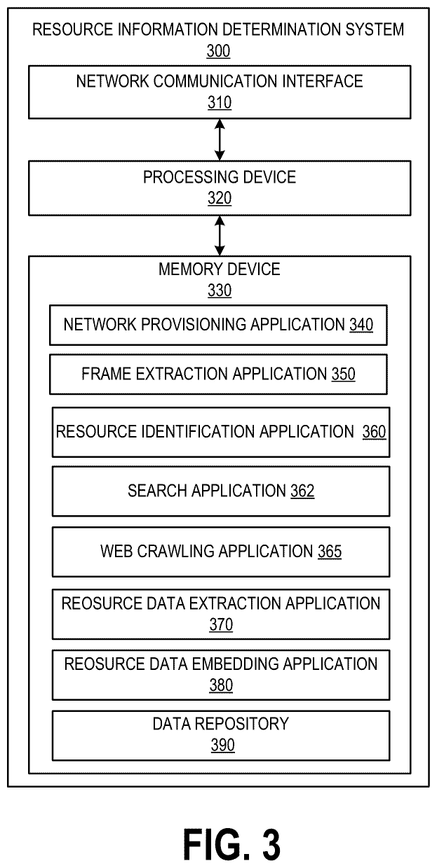

FIG. 3 provides a block diagram illustrating the resource information determination system 300 in greater detail, in accordance with embodiments of the invention. As illustrated in FIG. 3, in one embodiment of the invention, the resource information determination system 300 includes one or more processing devices 320 operatively coupled to a network communication interface 310 and a memory device 330. In certain embodiments, the resource information determination system 300 is operated by an entity, such as a financial institution. In some embodiments, the resource information determination system 300 is operated by an entity, such as a non-financial institution. In some embodiments, the resource information determination system 300 is owned or operated by the entity of the entity system 200. In some embodiments, the resource information determination system 300 may be an independent system. In alternate embodiments, the resource information determination system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the resource information determination system 300 described herein. For example, in one embodiment of the resource information determination system 300, the memory device 330 includes, but is not limited to, a network provisioning application 340, a frame extraction application 350, a resource identification application 360, a search application 362, a web crawling application 365, a resource data extraction application 370, a resource data embedding application 380, and a data repository 390 comprising data processed or accessed by one or more applications in the memory device 330. The computer-executable program code of the network provisioning application 340, the frame extraction application 350, the resource identification application 360, the search application 362, the web crawling application 365, the resource data extraction application 370, and the resource data embedding application 380 may instruct the processing device 320 to perform certain logic, data-processing, and data-storing functions of the resource information determination system 300 described herein, as well as communication functions of the resource information determination system 300.

The network provisioning application 340, the frame extraction application 350, the resource identification application 360, the search application 362, the web crawling application 365, the resource data extraction application 370, and the resource data embedding application 380 are configured to invoke or use the data in the data repository 390 when communicating through the network communication interface 310 with the entity system 200, and/or the computing device system 400. In some embodiments, the network provisioning application 340, the frame extraction application 350, the resource identification application 360, the search application 362, the web crawling application 365, the resource data extraction application 370, and the resource data embedding application 380 may store the data extracted or received from the entity system 200, and the computing device system 400 in the data repository 390. In some embodiments, the network provisioning application 340, the frame extraction application 350, the resource identification application 360, the search application 362, the web crawling application 365, the resource data extraction application 370, and the resource data embedding application 380 may be a part of a single application.

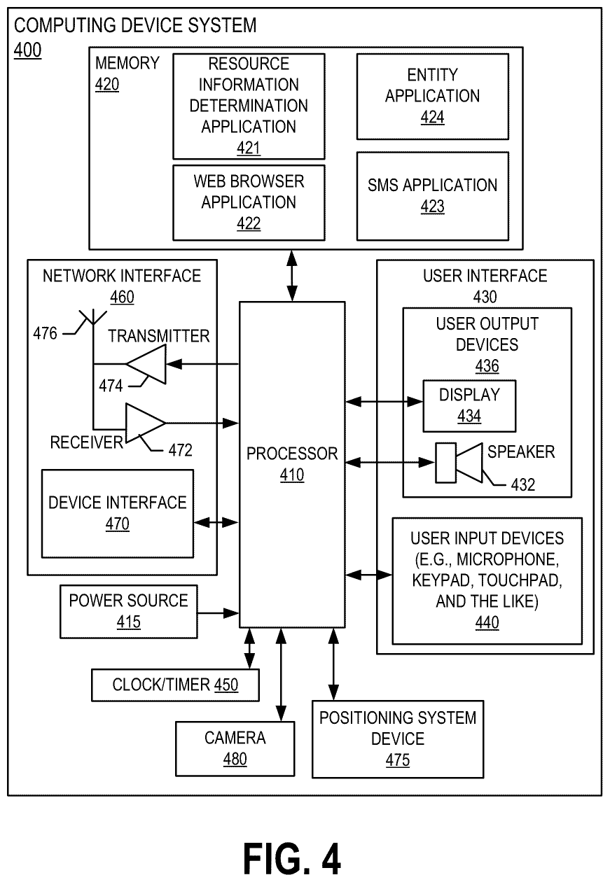

FIG. 4 provides a block diagram illustrating a computing device system 400 of FIG. 1a in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a resource information determination application 421, entity application 424. These applications also typically instructions to a graphical user interface (GUI) on the display 430 that allows the user 110 to interact with the entity system 200, the resource information determination system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the resource information determination application 421 provided by the resource information determination system 300 allows the user 110 to access the resource information determination system 300. In some embodiments, the entity application 424 provided by the entity system 200 and the resource information determination application 421 allow the user 110 to access the functionalities provided by the resource information determination system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

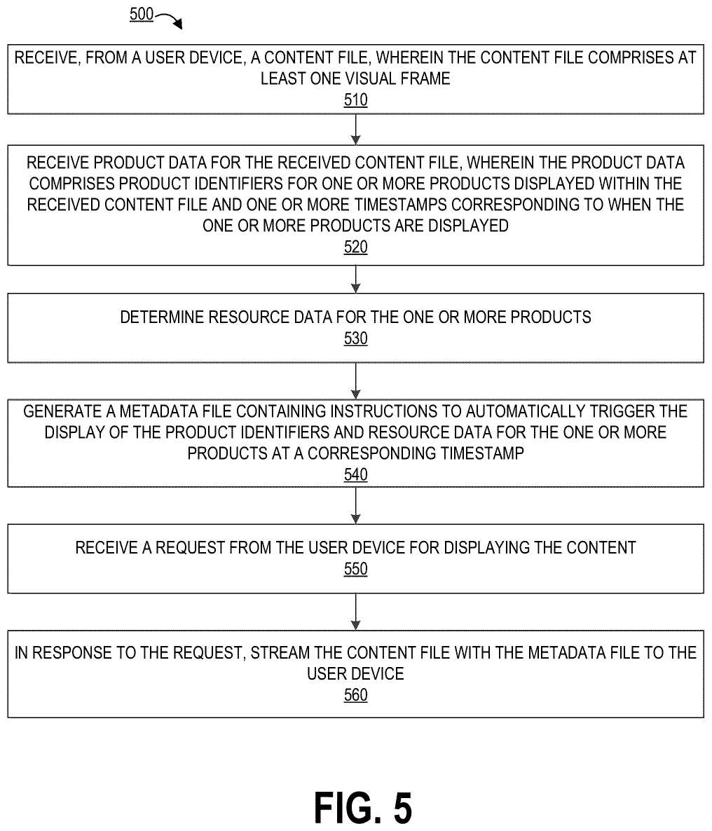

FIG. 5 provides a process flow for embedding extractable metadata elements within a channel-agnostic layer of audio-visual content, in accordance with an embodiment of the invention. As shown in block 510, the system receives, from a user device, a content file, wherein the content file comprises at least one visual frame. For instance, the content file might include, in some embodiments, a digital video file in any suitable format for streaming over a network (e.g., MP4., MOV., WMV., AVI., AVCHD., FLV, F4V, MKV, or the like). Next, as shown in block 520, the system receives product data for the received content file. In some embodiments, the system may generate product data via an intelligent machine learning engine process, such as by identification of products, items, or objects within the content file via a recurrent convolutional neural network (Mask R-CNN, or the like) using the machine learning architecture as described with respect to FIG. 1b. In some embodiments, the product data comprises product identifiers (stock keeping unit or “SKU” codes, universal product codes or “UPC” codes, stock codes, internet links, QR codes, bar codes, or the like) for products displays within the received content file. In some embodiments, the content file further comprises one or more timestamps corresponding to when the one or more products are displayed in the visual content (one or more frames, or the like). In some embodiments, the frames in which the products are displayed may be further determined by use of the machine learning architecture as described in FIG. 1b.

Next, as shown in block 530, the invention may determine resource data for the one or more products. For instance, the invention may crawl one or more websites, product pages, product catalogue databases, internet search history data, third party databases, marketing databases, cloud servers, or the like, in order to determine resource data for the one or more products. In some embodiments, the resource data may comprise a product price for a specific product. In some embodiments, the product price may be an average price among available, “trusted” online merchants for which the system has a pre-programmed list. In other embodiments, the product price may be a multi-faceted datapoint, such as a price range found across multiple merchants, a price range comparison of new and used items, a promotional price found at a specific merchant or during a specific time of year, or the like. In other embodiments, product price data may not be located, and it may be assumed that the product is unavailable, discontinued, temporarily sold out, or the like, in which case the resource data may simply refer to a channel to search for the item on a used product marketplace. In some embodiments, resource data may be further distilled to include only offers from merchants with which the entity has an ongoing relationship or affiliation. In some embodiments, resource data may be excluded for merchants or product sellers which are not trusted or exist on a pre programmed list of untrusted merchants. In some embodiments, the resource data may be in the form of one or more currency types, such that a product price may be displayed to users in an accurate currency given their IP address, device geolocation, or the like. In some embodiments, the resource data may require conversation based on a known current currency conversation rate. In some embodiments, the resource data may include a last known “lowest” and “highest” price for the item such that a user may be informed of whether or not current supply and demand for the product is affecting its price.

Next, as shown in block 540, the system may generate a metadata file containing instructions to automatically trigger the display of the product identifiers and resource data for the one or more products at a corresponding timestamp during playback, streaming, or the like, of the content file. For instance, a user may request, via the user device, via an entity application or the like, to stream the content file from the entity server or a third party server, as shown in block 550. In response, the system may stream the content file along with the metadata file to the user device.

As such, the system may provide the content file along with a metadata file containing the product identifiers and resource data. The entity application, third party application, or the like may be programmed to display an overlay via a graphical user interface of the metadata, such that the user may be informed about various products within the content file. In some embodiments, the overlay may be displayed in an interactive manner, such as an informational icon, or the letter “i” to indicate that the user may click on the icon and obtain further information about the product. In some embodiments, the user clicking on the interactive icon may pause the playback of the content file and display further information, such as the resource data and product price data, which may include links to view the items, purchase the items, or automatically add items to at “cart” within the graphical user interface without visiting an outside merchant website. In this way, the user may safely and securely add the items to a cart within the playback environment and may later “check out” using the playback environment as well, without ever needing to visit a third party merchant website. In this way, the entity managing the system of the invention, which may be a trusted financial institution, may be in a unique position to pre-populate resource account data and facilitate a secure transaction without requiring the user to disclose payment information. In some embodiments, the system may rely on previously authenticating the user to access the playback platform as a means for authenticating the user to access their resource accounts and use these accounts to purchase products from the content file.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for embedding extractable metadata elements within a channel-agnostic layer of audio-visual content, the system comprising:
at least one network communication interface;
at least one non-transitory storage device; and
at least one processing device coupled to the at least one non-transitory storage device and the at least one network communication interface, wherein the at least one processing device is configured to:
receive, from a user device, a content file, wherein the content file comprises at least one visual frame;
receive product data for the received content file, wherein the product data comprises product identifiers for one or more products displayed within the received content file and one or more timestamps corresponding to when the one or more products are displayed;
determine resource data for the one or more products; and
generate a metadata file containing instructions to automatically trigger the display of the product identifiers and resource data for the one or more products.

2. The system of claim 1, wherein the at least one processing device is configured to:
receive a request from the user device for displaying the received content file; and
in response to the request, cause the received content file and the metadata file to be displayed on the user device.

3. The system of claim 2, wherein causing the received content file and metadata file to be displayed on the user device further comprises streaming the received content file and metadata file to the user device.

4. The system of claim 2, wherein the metadata is displayed on the user device according to one or more specific timestamps of the one or more products.

5. The system of claim 2, wherein causing the received content file and metadata file to be displayed on the user device further comprises displaying a clickable graphical icon overlay over a video stream during a specific timestamp range.

6. The system of claim 1, wherein the resource data for the one or more products further comprises product description data, product resource data, and merchant data for the one or more products.

7. The system of claim 1, wherein the resource data further comprises a product price displayed on the user device in a currency according to the geolocation of the user device.

8. A computer program product for embedding extractable metadata elements within a channel-agnostic layer of audio-visual content, the computer program product comprising a non-transitory computer-readable storage medium having computer executable instructions for causing a computer processor to perform the steps of:
receiving, from a user device, a content file, wherein the content file comprises at least one visual frame;
receiving product data for the received content file, wherein the product data comprises product identifiers for one or more products displayed within the received content file and one or more timestamps corresponding to when the one or more products are displayed;
determining resource data for the one or more products; and
generating a metadata file containing instructions to automatically trigger the display of the product identifiers and resource data for the one or more products.

9. The computer program product of claim 8, wherein the computer executable instructions cause the computer processor to perform the steps of:
receiving a request from the user device for displaying the received content file; and
in response to the request, causing the received content file and the metadata file to be displayed on the user device.

10. The computer program product of claim 9, wherein causing the received content file and metadata file to be displayed on the user device further comprises streaming the received content file and metadata file to the user device.

11. The computer program product of claim 9, wherein the metadata is displayed on the user device according to one or more specific timestamps of the one or more products.

12. The computer program product of claim 9, wherein causing the received content file and metadata file to be displayed on the user device further comprises displaying a clickable graphical icon overlay over a video stream during a specific timestamp range.

13. The computer program product of claim 8, wherein the resource data for the one or more products further comprises product description data, product resource data, and merchant data for the one or more products.

14. The computer program product of claim 8, wherein the resource data further comprises a product price displayed on the user device in a currency according to the geolocation of the user device.

15. A computer implemented method for embedding extractable metadata elements within a channel-agnostic layer of audio-visual content, wherein the method comprises:
receiving, from a user device, a content file, wherein the content file comprises at least one visual frame;
receiving product data for the received content file, wherein the product data comprises product identifiers for one or more products displayed within the received content file and one or more timestamps corresponding to when the one or more products are displayed;
determining resource data for the one or more products; and
generating a metadata file containing instructions to automatically trigger the display of the product identifiers and resource data for the one or more products.

16. The computer implemented method of claim 16, wherein the method comprises:
receiving a request from the user device for displaying the received content file; and
in response to the request, causing the received content file and the metadata file to be displayed on the user device.

17. The computer implemented method of claim 16, wherein causing the received content file and metadata file to be displayed on the user device further comprises streaming the received content file and metadata file to the user device.

18. The computer implemented method of claim 16, wherein the metadata is displayed on the user device according to one or more specific timestamps of the one or more products.

19. The computer implemented method of claim 16, wherein causing the received content file and metadata file to be displayed on the user device further comprises displaying a clickable graphical icon overlay over a video stream during a specific timestamp range.

20. The computer implemented method of claim 15, wherein the resource data for the one or more products further comprises product description data, product resource data, and merchant data for the one or more products.
